(19) United States
(12) Patent Application Publication
(10) Pub. No.: US 2014/0047923 A1
(43) Pub. Date: Feb. 20, 2014

(54) Wear-Tolerant Electromagnetic Acoustic Transducer for use with Electromagnetic Acoustic Resonance Inspection Techniques

(71) Applicant: FRANK PASSARELLI, Camarillo, CA (US)

(72) Inventor: FRANK PASSARELLI, Camarillo, CA (US)

(21) Appl. No.: 13/961,350

(22) Filed: Aug. 7, 2013

Related U.S. Application Data
(63) Continuation of application No. PCT/US2012/024167, filed on Feb. 7, 2012.
(60) Provisional application No. 61/462,805, filed on Feb. 7, 2011.

(51) Int. Cl. G01N 29/24

(52) U.S. Cl. CPC G01N 29/2412
USPC 73/643

(57) ABSTRACT

Systems, methods, and devices for an Electromagnetic Acoustic Transducer (EMAT) comprising: a ceramic wear surface disposed about a first aperture of an EMAT tip portion, a transducing coil means disposed within a volume of the EMAT tip portion; where at least one magnet and an insulative surface may be interposed between the ceramic wear surface and the insulative structure. Optionally, a signal transmitting means may be configured to conduct a signal from the transmitting coil means via a second aperture of the tip.

### CROSS REFERENCE TO RELATED APPLICATIONS

This application is a Continuation of International Application No. PCT/US2012/024167 filed Feb. 7, 2012, which claims priority to and the benefit of U.S. Provisional Patent Application Ser. No. 61/462,805 filed Feb. 7, 2011, the disclosures of which are hereby incorporated by reference in their entirety herein for all purposes.

### TECHNICAL FIELD

This invention relates to electromagnetic acoustic resonance inspection techniques, and specifically to Electromagnetic Acoustic Transducers (EMATs) used in nondestructive testing.

### BACKGROUND

EMATs can be placed in close proximity to items under test. These items under test may be in motion relative to the EMATs. Shredded pieces of these items, i.e., fines, may end up in the test ends of the EMAT and migrate toward the coil, causing the coil to be inoperable.

### SUMMARY

Embodiments of the invention include an Electromagnetic Acoustic Transducer (EMAT) comprising: a tip, having a hollow interior, the tip comprising a front surface having a first aperture; a coil, where the coil may be disposed within the hollow interior of the tip and where the coil may be substantially coplanar with the front surface of the tip; and a ceramic wear surface, where the ceramic wear surface may be comprised of an electrically benign ceramic, e.g., yttrium-reinforced zirconium; and where the ceramic wear surface may be disposed about the first aperture of the tip and may be substantially coplanar with the front surface of the tip. In some embodiments, the EMAT may further comprise an epoxy, where the epoxy may be disposed about the coil and within the hollow interior of the tip, and where the epoxy may couple the ceramic wear surface to the front surface of the tip. In other embodiments, the EMAT may further comprise an insulative disk, where the tip further comprises a back surface having a second aperture, and where the insulative disk may be disposed over the second aperture of the tip. Additionally, the EMAT may comprise an epoxy, where the epoxy is disposed about the coil and within the hollow interior of the tip, and where the epoxy may couple the ceramic wear surface to the front surface of the tip and may couple the insulative disk, which may be comprised of a high dielectric constant, to the back surface of the tip. In some embodiments this EMAT further comprises at least one magnet, where the insulative disk may be disposed between the at least one magnet and the coil.

Methods of this invention may include a method of non-destructive testing of a material comprising: disposing a first Electromagnetic Acoustic Transducer (EMAT) lineally opposite a second EMAT, where the material under test may be interposed between the first EMAT and the second EMAT; transmitting a signal from the first EMAT; receiving the signal by the second EMAT; and transmitting the received signal for processing; where the opposed surfaces of the first EMAT and the second EMAT closest to the material under test may be in motion relative to the first EMAT and the second EMAT and/or may each be comprised of a ceramic wear surface, e.g., yttrium-reinforced zirconium.

Embodiments of the invention may include an electromagnetic acoustic transducer (EMAT) comprising: a ceramic wear surface disposed about a first aperture of an EMAT tip portion, a transducing coil means disposed within a volume of the EMAT tip portion; where at least one magnet and an insulative surface may be interposed between the ceramic wear surface and the insulative structure. In some embodiments the EMAT may include a signal transmitting means configured to conduct a signal from the transmitting coil means via a second aperture of the tip.

### BRIEF DESCRIPTION OF THE DRAWINGS

Embodiments are illustrated by way of example and not limitation in the figures of the accompanying drawings, and in which:

FIG. 1 depicts an exemplary EMAT in an exploded view; and

FIG. 2 depicts an exemplary transmitting EMAT sensor and an exemplary receiving EMAT sensor pair lineally disposed opposite one another, where a wire is shown interposed between the tips of each.

### DETAILED DESCRIPTION

The methods described herein are intended to address several issues that have presented problems for the implementation of EMATs used in the industrial or in the high volume component inspection environment. While these methods have particular application in EMATs that are used in the application of the electromagnetic acoustic resonance and specifically the techniques used in the continuous wave methods of the acoustic resonance inspection systems, the application of these methods can be favorably applied to conventional pulsed EMAT implementations. The wear problem became most problematic when the transducers designs became smaller and smaller. The applications mainly comprise of small items such as small diameter tubing, fasteners, or stamped or forged components including, engine valves presenting problems for the application of EMATs. They must be small in size to accommodate tight radiuses and to allow for their placement very near the surface of the article under test and the close proximity of the transducer to each other. While not in contact with the surface, their near surface proximity often traverses components with sharp hardened edges and contour transitions rapidly fatigues traditional transducer wear face materials and wear coatings.

A low dielectric constant, extremely hard, non-metallic material such as a thin machined ceramic material as a tile, for example, may be selected from: silicon carbide, sapphire or other industrial ceramic. This tile may be placed directly onto the coil face of the transducer. This entire assembly may then be cemented in a hard epoxy within the transducer tip. Preferably, the hard wear face is backfilled with a void-filling hard compound in order to ensure that the structural rigidity required to support the brittle wear plate is present. Depending upon the transducer application, a field focusing pole piece may be used to reduce the transducer frontal area to enable coverage of small diameter or tight radius contours. The coil may be backed with a high dielectric constant insulative tile material including mica or perovskite, reducing direct or induced electromagnetic coupling into the magnet assembly. This reduces the unwanted eddy current losses generated by the coil coupling into the magnet assembly.

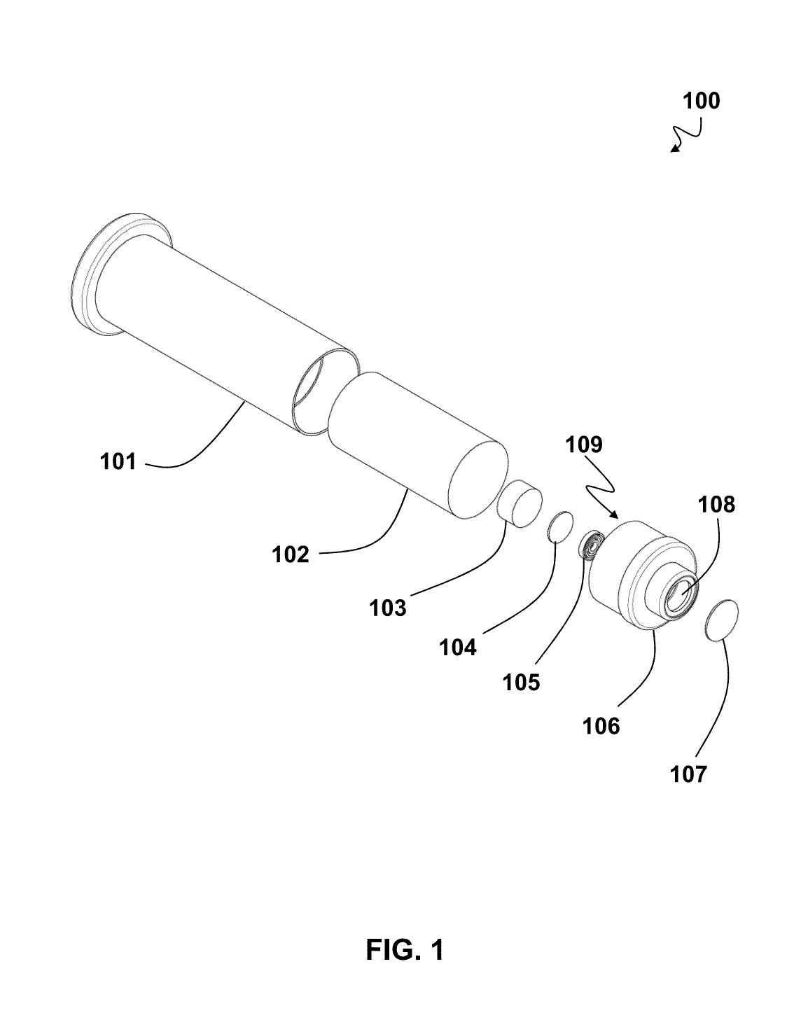

FIG. 1 depicts an exploded view of an exemplary transducer assembly 100 exclusive of its cable assembly and its ferritic steel cable anchor. FIG. 1 shows an exemplary transducer embodiment with a ceramic wear plate 107 that may be imbedded into the housing tip 106, where the housing tip 106 comprises a first aperture 108 and a second aperture 109. This may be backed by a pancake coil 105 wound of either regular single filament magnet wire or multifilament magnet wire, sometimes called litz wire particularly useful at higher frequencies, and a field reducing magnet 103 faced with an insulative tile 104. The thin insulative tile 104 may be of a high dielectric constant and may protect the coil 105 from contact with an electrically conductive magnet 103,102 backing the coil. For example, a 0.005″ titanate-based ceramic with a dielectric constant of 8,000 to 12,000 may be used. The pancake coil 105 may be constructed of a poly-coated copper wire, e.g., for testing titanium, having an exemplary range of approximately 1.5 mm to 3 mm in diameter. For example, the coil 105 may be ninety turns of thirty-three gauge wire. The coil 105 may have a responsive frequency in the range of 10-15 MHz. The field reducing magnet 103 is then stacked onto a larger, more powerful, magnet structure 102 contained within a housing 101 and integrated tip assembly 106. The field focusing/reducing magnet 103 may be a neodymium, iron, boron magnet having exemplary field strengths of 42 to 52 Mega Gauss Oersteds, and the larger magnet 102 depicted in FIG. 1 may be of the same material having a high field strength value such as 55 MGOE.

Epoxy sealing compounds for both the tip section and housing body are not depicted. A hard epoxy sealing compound may be disposed on the backside of the ceramic wear plate 107 to provide durability. In some embodiments, the ceramic wear plate 107 may be serviced, e.g., the EMAT may be resurfaced and a new ceramic wear plate may be affixed, at least once. The wear plate 107 may be comprised of a thin machined, electrically benign industrial ceramic or natural mineral tile that is affixed to the housing 101 and coil-magnet assembly. This may greatly improve transducer life in high volume industrial applications.

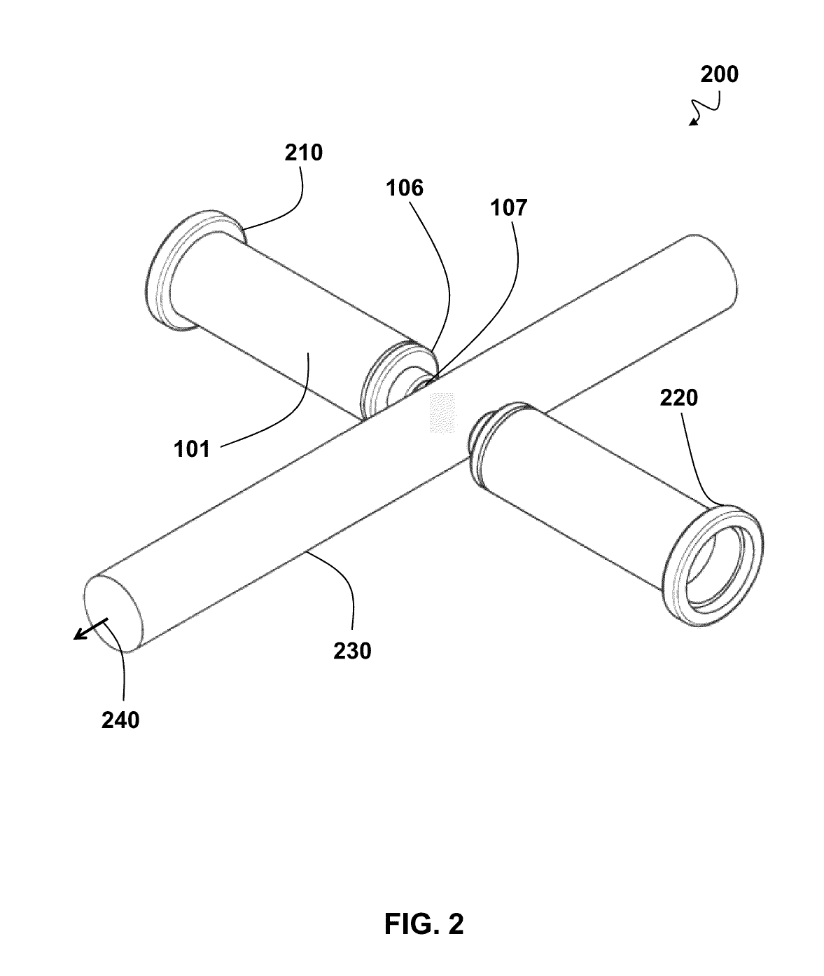

FIG. 2 depicts an exemplary embodiment 200 comprising an exemplary transmitting EMAT sensor 210 and an exemplary receiving EMAT sensor 220 pair disposed about a wire 230. The wire may be fixed or have a direction of motion 240 relative to the EMAT sensors 210, 220. The EMAT sensors 210, 220 may be composed of the materials depicted in the exploded view of FIG. 1. The transmitting EMAT sensor 210 may excite electrical surface eddy currents in the material being tested, e.g., a wire 230, and convert them into mechanical sound waves via the Lorenz force to bring about a stable acoustic resonance. The receiving EMAT sensor 220 may detect the resonance in the material being tested, and present the modulated signal for processing. This process creates carefully bounded, acoustic fields in the areas directly under the sensor faces. The material being tested may continuously move past the EMAT sensors 210, 220 at high feed rates, e.g., up to 2,500 feet per minute. The material to be tested may also be stationary, e.g., engine components, fasteners, and medical devices. While not exclusive to this application, this invention has particular importance for use in high frequency electromagnetic acoustic resonance applications. A ceramic wear plate 107 affixed, e.g., by a hard epoxy, to the tip assembly 106 of the transmitting EMAT sensor 220 protects the coil (FIG. 1, 105) from damage, e.g., caused by pieces of the material being tested that are magnetically attracted to the magnet structure (FIG. 1, 102) contained within a housing 101. A ceramic wear plate may also be affixed to the receiving EMAT sensor 220. Both of the EMAT sensors may be positioned at a distance proximate to, but not in direct contact with, the material to be measured, e.g., one five-thousandth to one fifty-thousandth of an inch from the material to be measured. The ceramic wear plate 107 may be thin, e.g., up to one five-thousandth of an inch, electrically inert, and harder than the material to be measured, e.g., having a Rockwell hardness in the range of 77 to 81, and preferably a Rockwell hardness 75 and above. The materials need to be hard, making them puncture and wear tolerant: tough, giving them fracture resistance as opposed to being brittle. The ceramic wear plate 107 may be made of any electrically inert, machinable ceramic material having low dielectric constant, e.g., yttrium-reinforced zirconium, industrial diamonds, silicon carbide, alumina, or sapphire.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

1. An Electromagnetic Acoustic Transducer (EMAT) comprising:
a tip, having a hollow interior, the tip comprising a front surface having a first aperture;
a coil, wherein the coil is disposed within the hollow interior of the tip and wherein the coil is substantially coplanar with the front surface of the tip; and
a ceramic wear surface, wherein the ceramic wear surface is comprised of an electrically benign ceramic; and
wherein the ceramic wear surface is disposed about the first aperture of the tip and is substantially coplanar with the front surface of the tip.

2. The EMAT of claim 1 further comprising an epoxy, wherein the epoxy is disposed about the coil and within the hollow interior of the tip, and wherein the epoxy couples the ceramic wear surface to the front surface of the tip.

3. The EMAT of claim 1 wherein the ceramic wear surface is comprised of yttrium-reinforced zirconium.

4. The EMAT of claim 1 further comprising an insulative disk, wherein the tip further comprises a back surface having a second aperture, and wherein the insulative disk is disposed over the second aperture of the tip.

5. The EMAT of claim 4 further comprising an epoxy, wherein the epoxy is disposed about the coil and within the hollow interior of the tip, and wherein the epoxy couples the ceramic wear surface to the front surface of the tip and couples the insulative disk to the back surface of the tip.

6. The EMAT of claim 5 wherein the insulative disk is a ceramic material of a high dielectric constant.

7. The EMAT of claim 5 further comprising at least one magnet, wherein the insulative disk is disposed between the at least one magnet and the coil.

8. A method of non-destructive testing of a material, the method comprising:
disposing a first Electromagnetic Acoustic Transducer (EMAT) lineally opposite a second EMAT, wherein the material under test is interposed between the first EMAT and the second EMAT;
transmitting a signal from the first EMAT;
receiving the signal by the second EMAT; and
transmitting the received signal for processing;
wherein the opposed surfaces of the first EMAT and the second EMAT closest to the material under test are each comprised of a ceramic wear surface.

9. The method of claim 8 wherein the material under test is in motion relative to the first EMAT and the second EMAT.

10. The method of claim 8 wherein the ceramic wear surface is yttrium-reinforced zirconium.

11. An electromagnetic acoustic transducer (EMAT) comprising: a ceramic wear surface disposed about a first aperture of an EMAT tip portion, a transducing coil assembly disposed within a volume of the EMAT tip portion;
wherein at least one magnet and an insulative surface are interposed between the ceramic wear surface and the insulative surface to form a structure.

12. The EMAT of claim 11 wherein a signal transmitting assembly is configured to conduct a signal from the transmitting coil assembly via a second aperture of the tip.
